(19) United States
(12) Patent Application Publication
(10) Pub. No.: US 2017/0308596 A1
(43) Pub. Date: Oct. 26, 2017

(54) DATAMART: AUTOMATED SYSTEM AND METHOD FOR TRANSFORMING DATA FOR PUBLISHING AND CONSUMPTION

(71) Applicant: Aeris Communications, Inc., Santa Clara, CA (US)

(72) Inventors: Yixiang CHEN, Palo Alto, CA (US); Syed Zaeem HOSAIN, San Jose, CA (US); Vikram VISWANATHAN, Saratoga, CA (US); Drew S. Johnson, San Jose, CA (US)

(21) Appl. No.: 15/648,669

(22) Filed: Jul. 13, 2017

Related U.S. Application Data
(63) Continuation-in-part of application No. 14/207,378, filed on Mar. 12, 2014.
(60) Provisional application No. 61/780,234, filed on Mar. 13, 2013.
(60) Provisional application No. 61/878,554, filed on Sep. 16, 2013.
(60) Provisional application No. 62/362,400, filed on Jul. 14, 2016.

(51) Int. Cl. G06F 17/30; G06Q 30/06

(52) U.S. Cl. CPC G06F 17/30563; G06Q 30/0601; G06Q 30/0611

(57) ABSTRACT

The present invention is directed towards a computer-implemented method and system for transactions involving device data due to operations of one or more devices. The method comprises transforming, by applying rules, the device data from the one or more devices into formatted device data that is useable for the transactions; sending the formatted device data to a storage location; generating a descriptive listing of the formatted device data; providing public access to the descriptive listing; and facilitating transactions involving the formatted device data in response to receiving information from the descriptive listing.

### CROSS-REFERENCE TO RELATED APPLICATIONS

This application is a continuation-in-part application of U.S. application Ser. No. 14/207,378, filed on Mar. 12, 2014, which claims priority to U.S. provisional application Ser. No. 61/780,234, filed on Mar. 13, 2013, and U.S. provisional application Ser. No. 61/878,554, filed on Sep. 16, 2013, and claims priority to U.S. provisional application No. 62/362,400, filed Jul. 14, 2016; the entire disclosures of each are incorporated herein.

### FIELD OF THE INVENTION

The present invention is directed to the management of data received from devices on a network and transactions involving device data by transforming data gathered from devices on a network for publishing and consumption.

### BACKGROUND

An increasing number of devices or machines are enabled for connectivity to cellular or other wireless network services, including telephones and tablet computers as well as devices designed for machine-to-machine communications, such as telematics devices in automobiles or devices enabled for monitoring and reporting on equipment or machines, such as appliances, or services, such as utilities or tracking assets. These devices may collect data generated by the equipment or service that can be used for multiple purposes by a number of different parties, such as monitoring the operation of the machine or service associated with the device or the environment in which the machine or service is operating.

Managing and transforming the data received from devices for Internet of Things (IoT) such that it can be searched and purchased either when it first becomes published or afterwards, or as future data at regular intervals, and searching for availability of such data for purchase according to the needs of different interested parties poses a significant challenge to every party in the data chain.

Accordingly, what is needed is a system and method to address the issue of managing and transforming the data received from devices and transactions involving device data. The present invention addresses such a need.

### SUMMARY OF THE INVENTION

The present invention is directed towards a computer-implemented method and system for transactions involving device data generated by a plurality of events or entities, including users, machines or services, and collected by wireless devices (referred to herein for convenience as “device data”).

The computer-implemented method for transactions involving device data due to operations of one or more devices comprises transforming, by applying rules, the device data from the one or more devices into formatted device data that is useable for the transactions; sending the formatted device data to a storage location; generating a descriptive listing of the formatted device data; providing public access to the descriptive listing; and facilitating transactions involving the formatted device data in response to receiving information from the descriptive listing. The computer-implemented system for transactions involving device data due to operations of one or more devices comprises a database to receive data from one or more devices; a module for transforming, by applying rules, the device data from the one or more devices into formatted device data that is useable for the transactions; sending the formatted device data to a storage location; generating a descriptive listing of the formatted device data; and providing public access to the descriptive listing; and a gateway for facilitating transactions involving the formatted device data in response to receiving information from the descriptive listing.

### BRIEF DESCRIPTION OF THE DRAWINGS

FIG. 1A illustrates a block diagram depicting an example of the relationship between the resources associated with transactions involving device data, transformation of device data into searchable data, publishing of searchable device data indexed by data descriptions in a data directory for search of the device data, and consumption of and management of access to the transformed device data.

FIG. 1B illustrates a block diagram depicting an example of the relationship between different entities used during the management of device data feeds.

FIG. 2 illustrates an example of a data model as defined by the system.

FIG. 3A illustrates an example of publishing device data to a receiver endpoint.

FIG. 3B illustrates a process for publishing device data descriptions as a data directory that can be searched or queried.

FIG. 4A is a flow diagram illustrating various steps involved in the process of data decoration.

FIG. 4B illustrates an example of data decoration mapping.

FIG. 5 is a flow diagram illustrating various steps involved in transactions involving device data using the method and system according to an embodiment.

FIG. 6 illustrates an example of a system to transactions involving device data with pricing based on data accuracy and privacy.

FIG. 7A is a flow diagram illustrating various steps involved in processing data using subscription rules.

FIG. 7B illustrates an example of a rule.

FIG. 8A is a flow diagram illustrating use of application programming interface (API) keys to govern access to containers for end users or end user applications to retrieve data from a container.

FIG. 8B illustrates examples of writing and/or reading data and one “container” API for both data subscription and data query.

FIG. 9 illustrates an example of processing of raw device data as directed by subscription information, according to an embodiment of the present invention.

FIG. 10 illustrates a data processing system suitable for storing the computer program product and/or executing program code in accordance with an embodiment of the present invention.

### DETAILED DESCRIPTION

The present invention is directed to the transactions involving device data by transforming data gathered from devices on a network for publishing and consumption.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention relates to any data generated by a plurality of events or entities, including users, machines or services, and collected by wireless devices operating on a network, whether the device is used by a human or is used in applications involving machine-to-machine communications; all such collected data is referred to herein for convenience as “device data”.

Many deployed devices, whether used by consumers or in machine-to-machine applications, collect data that others may wish to use. For example, a refrigerator manufacturer may collect data using logic in the refrigerator about device performance and use a device for cellular connectivity embedded in the refrigerator to send that data to a central location for processing for the manufacturer's own use, such as monitoring and improving performance, while other persons, such as persons or entities selling energy services, such as solar power systems, may want to access the data originally collected by the manufacturer about home appliances and use that data for another purpose selected by the end user, such as tracking and analysis of energy consumption by similar devices in that particular location or under particular environmental conditions, such as temperature or particular weather patterns.

Collected raw data, however, may not be useful either to the original party collecting it or to any other party until it has been transformed by sorting or processing at least to some degree. In addition, persons other than the original party collecting data may not be aware that the data is available. Accordingly, if the original party collecting data wishes to allow others to purchase and/or use that data, there is presently no simple way to allow efficient access to and acquisition or purchase by other parties of meaningful data. There may also be privacy considerations that would require limiting access of certain parties to certain data.

In any system involving devices on a network, device data may be sent to some location for processing and storage and descriptions of that data may be made available through publication in a searchable directory for discovery by end users. Since different end users may only want to receive, or may only be authorized to receive, certain portions of the data feed gathered from any given device or a group of devices, a method and system are required for processing the data so that it is categorized according to selected parameters, or data descriptions, publishing data descriptions of that processed data as a directory searchable by end users (whether human or machine-enabled applications), managing the process of purchase and sale of the selected data to end users, and managing access by different end users to such purchased data.

Accordingly, there is a need to be able to categorize raw device data that has been collected, save processed device data in a data store so that it is searchable by an application used by parties, whether the original collector of the device data or third parties, and to authorize and manage access to that device data, including setting choices in how to receive the saved or purchased data. Some parties may wish to receive it immediately in real-time, some may want some device data to be sent to their applications either continuously or at regular intervals depending on selected parameters, and some may wish to direct other applications to query the device data store for stored or real time data. These services are not accommodated by existing models for transactions involving device data by transforming data gathered from devices on a network. What is needed to solve these issues is a method and system providing one easy-to-use end-to-end solution that overcomes the above-identified issues.

The present invention addresses this need by allowing entities to economically and accurately transform the data by gathering, processing and storing the data generated by a plurality of events or entities, including users, machines or services, and collected by wireless devices operating on a network and make that device data available for publishing and transactions such as sale and purchase. The invention further allows end users or end user applications to search or discover and purchase the device data and securely access the purchased data in accordance with a subscription model chosen by the purchaser.

A computer-implemented method and system for transactions involving device data due to operation of one or more devices are disclosed. The computer-implemented method for transactions involving device data due to operations of one or more devices comprises transforming, by applying rules, the device data from the one or more devices into formatted device data that is useable for the transactions; sending the formatted device data to a storage location; generating a descriptive listing of the formatted device data; providing public access to the descriptive listing; and facilitating transactions involving the formatted device data in response to receiving information from the descriptive listing.

The computer-implemented system for transactions involving device data due to operations of one or more devices comprises a database to receive data from one or more devices; a module for transforming, by applying rules, the device data from the one or more devices into formatted device data that is useable for the transactions; sending the formatted device data to a storage location; generating a descriptive listing of the formatted device data; and providing public access to the descriptive listing; and a gateway for facilitating transactions involving the formatted device data in response to receiving information from the descriptive listing.

The method and system further allows management of access to the device data purchased by the user using one or more application programming interface (API) keys.

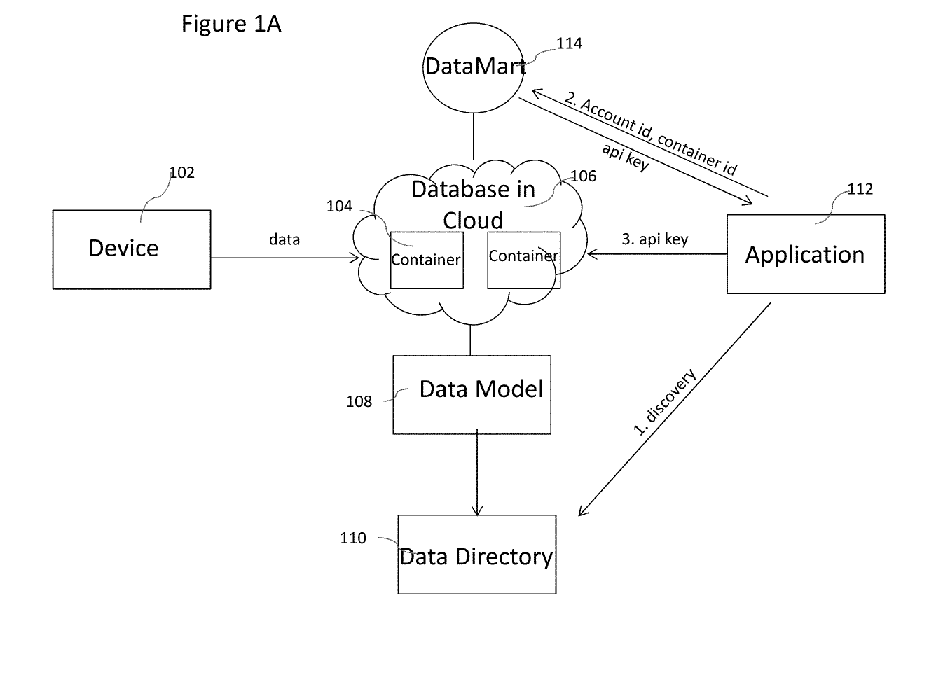

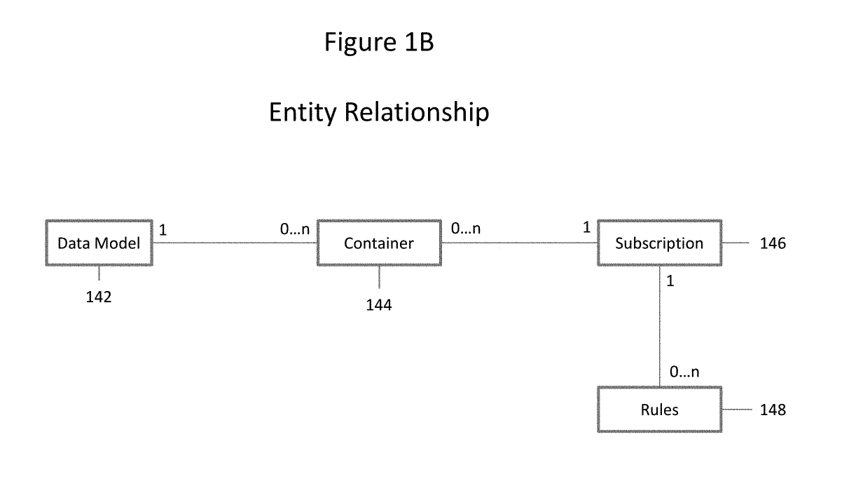

FIG. 1A illustrates a block diagram of relationship between the resources associated with transactions involving device data, transformation of device data into searchable data, publishing of searchable device data indexed by data descriptions in a data directory for search of the device data, and consumption of and management of access to the transformed device data. A device 102 is associated with a data model 108, which is associated with at least one container 104 in a database 106. The device 102 posts data to a container 104 based on its associated data model, which may include one or more data field definitions or data descriptions, such as types, units of measurement or other metadata, such as “name”, “model number”, “location” or “temperature”. The database system 106 looks up the data model 108 associated with the container 104 and stores the received data indexed by time or other parameter in the database 106. The system then checks if the index located in the container is configured for any parameter associated with data fields in the data model 108. If it is, the system extracts the parameter from the device data and stores data by the value index of the parameter. If the index is not configured for any parameter, the system further checks if data decoration for that device data is configured. If data decoration is configured, the system processes the data decoration and stores the result as transformed or formatted data. If data decoration is not configured, the system stores the device data as indexed data without further processing for future use since the indexing is performed regardless of data decoration.

The system publishes the data descriptions as a data directory 110 that is searchable or can be queried describing the device data available for purchase. The data directory 110 may include data descriptions further comprising data parameters such as, but not limited to, account ID, container ID, meta data of the data model, relevance, privacy configuration and price. For example, the device data may be listed as private, so if the application wants to access that device data at a premium, and if it is available for sale at a premium, it can do so through this interface. Additionally, the data directory may display the rating for the available device data based on relevance, frequency of availability and quality of device data such as completeness, accuracy etc. from a particular source.

An end user or end user application 112 may engage with a data discovery and purchase application 114 to discover if specific types of device data are available and to complete a purchase. In an embodiment, the end user may create an account with the application and store information such as username, password, order history and end user data receiver endpoints to receive purchased device data. The data discovery and purchase application may initiate a discovery process via step 1 by querying the data directory 110 to find available device data. If the application finds the requested data description in the data directory, it may initiate a transaction with the datamart system entity 116 by asking for a price quote for device data meeting the requested data description and the types of subscription available. The application may report the availability of device data meeting the requested data description, the types of subscription available for receiving device data and the quoted price to the end user. If the end user agrees with the quoted price, the end user may direct the application to complete the purchase via step 2. The datamart would send to the application an API key for that account ID to access device data in the particular containers based on the purchase parameters via step 3, and the application may forward the API key to the end user or store the API key in the end user's account at the application.

The price quoted by the datamart data sale and purchase system 116 can be variable depending on the amount of device data, time of purchase and duration. For example, the device data can be available at the quoted price for 24 hours. If not purchased within that time, the price may change. For example, for real-time or future device data, the price may go up as the time of purchase is closer to the time of data generation, whereas for historical/stored device data, the price may go down as the device data becomes old. The datamart data sale and purchase system may choose to withdraw the offer to sell at the expiration of such time period or renew the offer at the same price or renew the offer at a different price.

In an alternate embodiment, the datamart data sale and purchase system 116 may choose to withdraw the offer to sell at the expiration of such time period or renew the offer at the same price or renew the offer at a different price automatically upon expiration of the earlier offer.

In an alternate embodiment, the data discovery and purchase application 114 may enable one or more end users or end user applications to offer a certain price for purchasing the available device data as a bid. If the datamart data sale and purchase system 116 agrees with the bid, it may accept the offer and proceed with the sale of that device data at the offered price. In such a scenario, there can be multiple end users bidding for particular device data, and the datamart data sale and purchase system may offer to sell to one or more of the highest bidders. The datamart data sale and purchase system can further require that end users offer a minimum price set for particular device data and/or that there be a maximum number of end users that can access the particular device data at any given time.

In an embodiment, the datamart data sale and purchase system may set a maximum number of subscriptions for particular device data, i.e., a maximum number of end users that can access that device data at any particular time so that once purchase transactions for that number have been completed, the device data will not be available for sale until new subscriptions become available, such as upon expiration of previous purchases or subscriptions, or opening of new purchase cycles for newly available device data.

In yet another embodiment, the device data owner may be different from the data management system that uses the data management system to sell their gathered device data to applications or other users looking to purchase such device data. In an embodiment, the pricing for selling and buying data may be based on data accuracy and privacy. Pricing according to importance of privacy in acquired data is important since privacy has value and data collected from sensors (sensor data, also known as source data or device data) can be intrusive. A system based only on permission by the party from whom the data is collected (a data owner) does not value privacy in a market setting. Compensating data owner for privacy loss incentivizes the owner to share data, which facilitates market formation and growth. Data owner can be a person or a corporation.

FIG. 1B illustrates a block diagram depicting an example of the relationship between different entities used during the management of device data feeds and the publishing and consumption of data. A device is associated with a data model 142, which is associated with a number of containers 144. A device posts data into the container 144 based on the data model 142 associated with that device and container 144. The container 144 is also associated with a subscription 146, meaning a set of rules and scripts associated with a particular end user or end user application. Each subscription 146 is associated with a rule 148, uniquely identified with the identifier of the subscription 146. The data posted in a container 144 is processed according to the subscription 146 associated with that container, according to the rules 148 associated with the subscription 146.

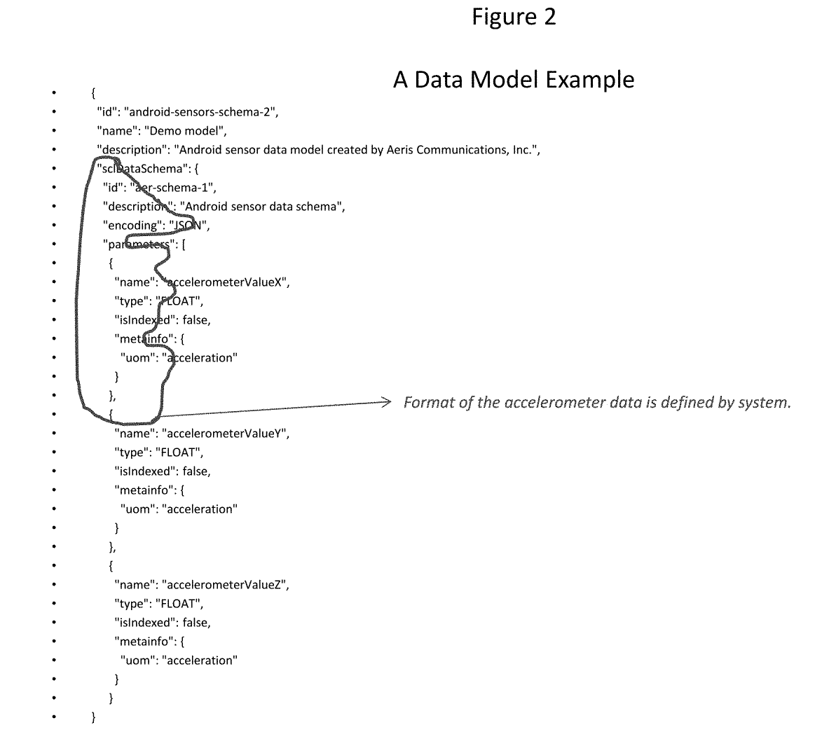

FIG. 2 illustrates an example of a data model. As shown in the example, a data model comprises one or more data fields, for example, “name”, “type”. The data model may also include data field definition, type of data, unit of measurement and/or other meta-data. A container is associated with a specific data model depending on the data description for that data model. System uses data models to extract data fields from raw device data for indexing, data decoration and subscription rule processing.

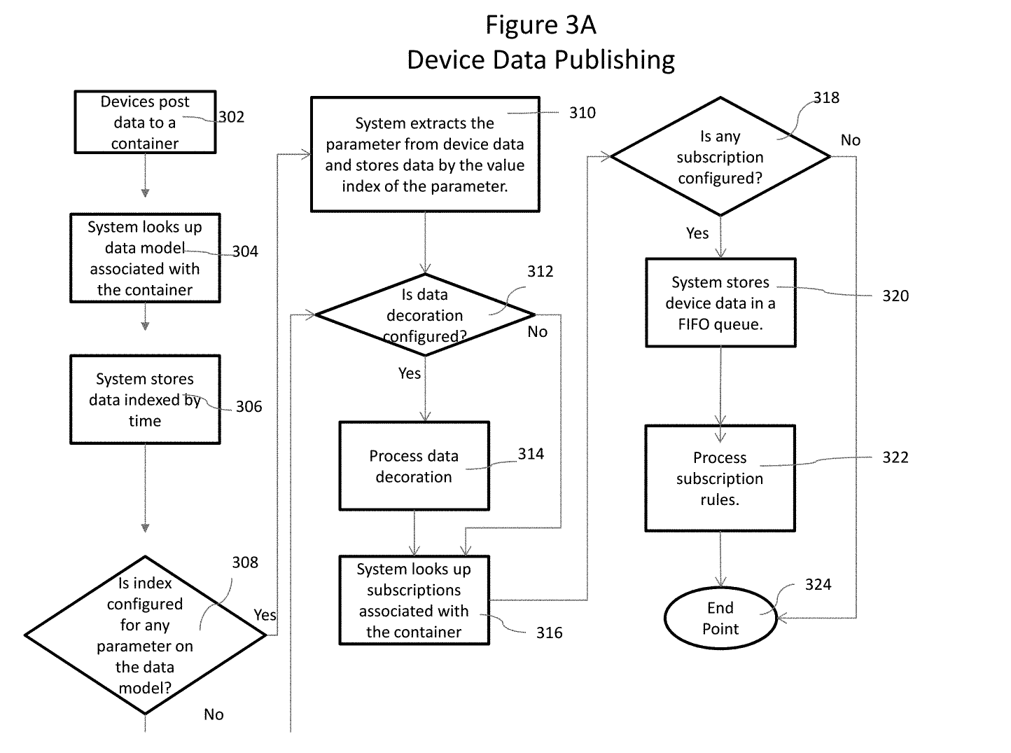

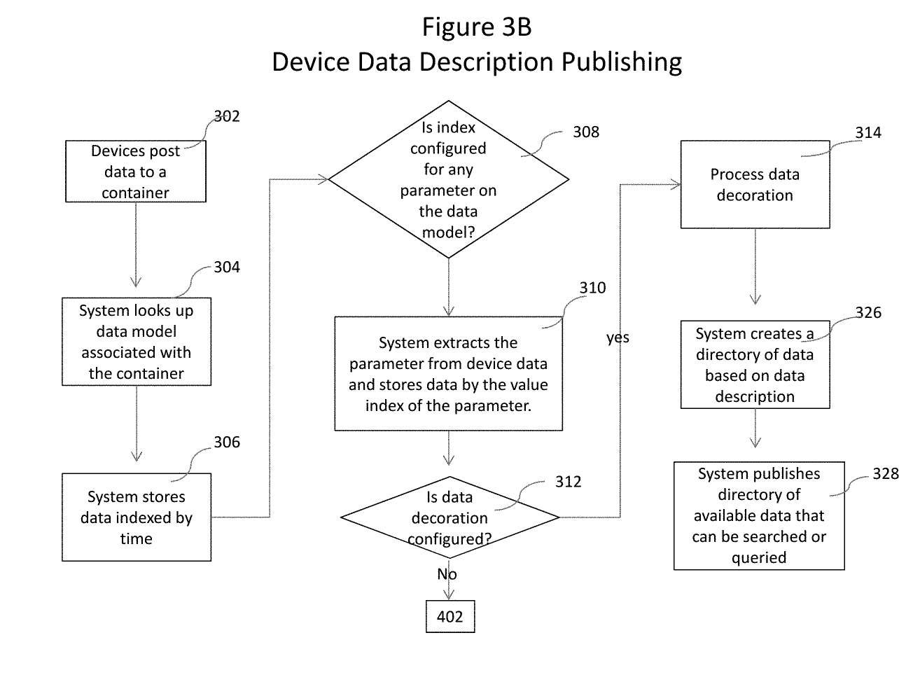

FIG. 3A sets forth a process for publishing device data to a receiver endpoint in accordance with one of the embodiments. A device posts data to a container via step 302 based on data description. The system looks up the data model associated with the container step 304 and stores the received data indexed by time step 306. The system then checks if the index is configured for any parameter on the data model via step 308. If it is, the system extracts the parameter from the device data and stores data by the value index of the parameter via step 310. If the index is not configured for any parameter, the system further checks if the data decoration for that data is configured via step 312. If the data decoration is configured, the system processes the data decoration via step 314. If the data decoration is not configured, the system looks up subscriptions associated with the container step 316. Alternatively, the system looks up subscriptions associated with the container step 316, after processing the data decoration. Thus, the system may or may not process data decoration depending on the configuration.

The system then checks if any subscription is configured, or associated, with the data via step 318. If it is, the system stores the device data in a queue for publishing via step 320, processes the subscription rules step 322 and publishes the processed data by forwarding it to a receiver endpoint as directed by the subscription rules step 324. However, if no subscription is configured, the data is stored away without further evaluation.

FIG. 3B illustrates a process for publishing device data descriptions as a searchable data directory. The process of publishing device data descriptions provides public access to the descriptive listing generated for the formatted device data. The public access may be limited to particular audience, for example, subscription based, or to everyone as required by the data owner. The data management system stores data descriptions in a directory which can be either searched or queried for required device data using different parameters such as time, location, type etc. Once the end user or end user application confirms the availability of the required device data, the end user can proceed to complete purchase of that device data. For example, a device posts data to a container via step 302 based on data description. The system looks up the data model associated with the container step 304 and stores the received data indexed by time step 306. The system then checks if the index is configured for any parameter on the data model via step 308. If it is, the system extracts the parameter from the device data and stores data by the value index of the parameter via step 310. If the index is not configured for any parameter, the system further checks if the data decoration for that device data is configured via step 312. If the data decoration is configured, the system processes the data decoration via step 314. If data decoration is not configured, the system stores the device data as indexed data without further processing for future use since the indexing is performed regardless of data decoration. Alternatively, the system stores the device data away for future use, after processing the data decoration as formatted or transformed data. Thus, the system may or may not process data decoration depending on the configuration.

In an embodiment, the system then creates a directory of received device data based on data description via step 326 and publishes the directory of available device data that can be searched or queried via step 328.

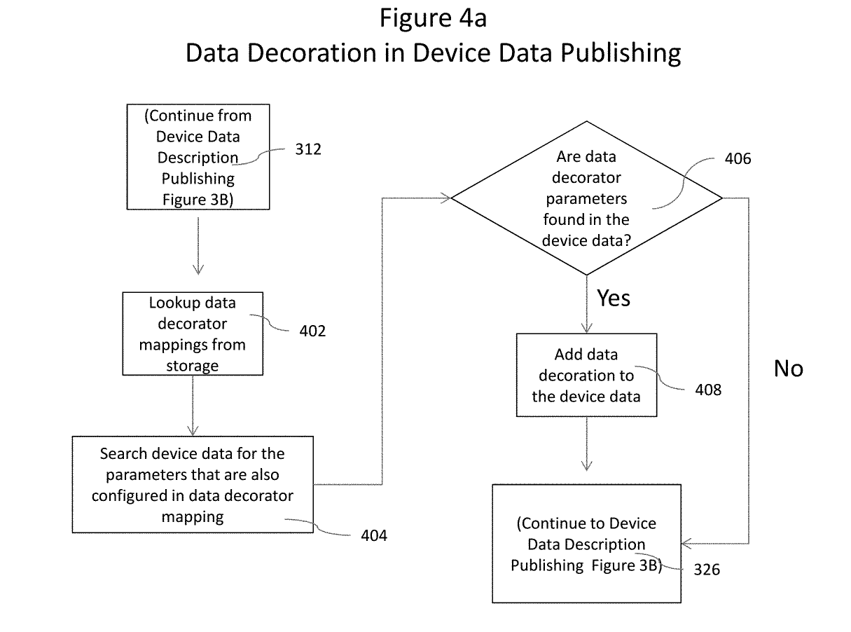

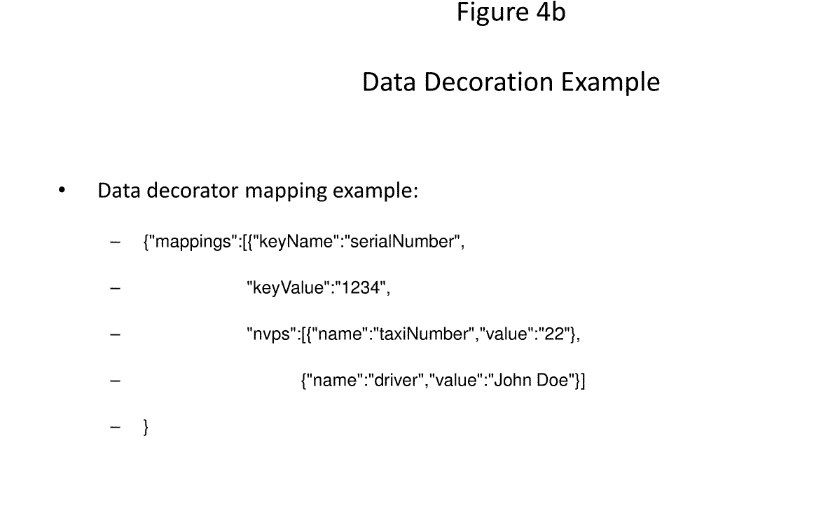

FIG. 4a is a flow diagram illustrating various steps involved in the process of data transformation by augmenting or enriching received device data with other external data to reduce the amount of data that a device needs to send and to improve usefulness to the end user through a process known as data decoration. If data decoration is configured for any device data associated with a particular container, the system processes the data decoration step 314, by looking up decorator mappings from storage via step 402. The system then searches the device data for parameters that are also configured in data decorator mapping via step 404. If the data decorator parameters are found in the device data via step 406, the system adds the data decoration to the device data via step 408.

FIG. 4b illustrates an example of data decoration mapping. In an example, the application enablement platform will see the instruction for performing data decoration mapping on the device data received from a device and then add parameters such as taxi number and driver name in the device data containing parameters such as serial number and received data for that parameter such as location to make it more useful before storing the augmented data feed in the container. The application of the end user taxi company can now process the device data as if the device had sent the taxi number and driver name as well as the location data.

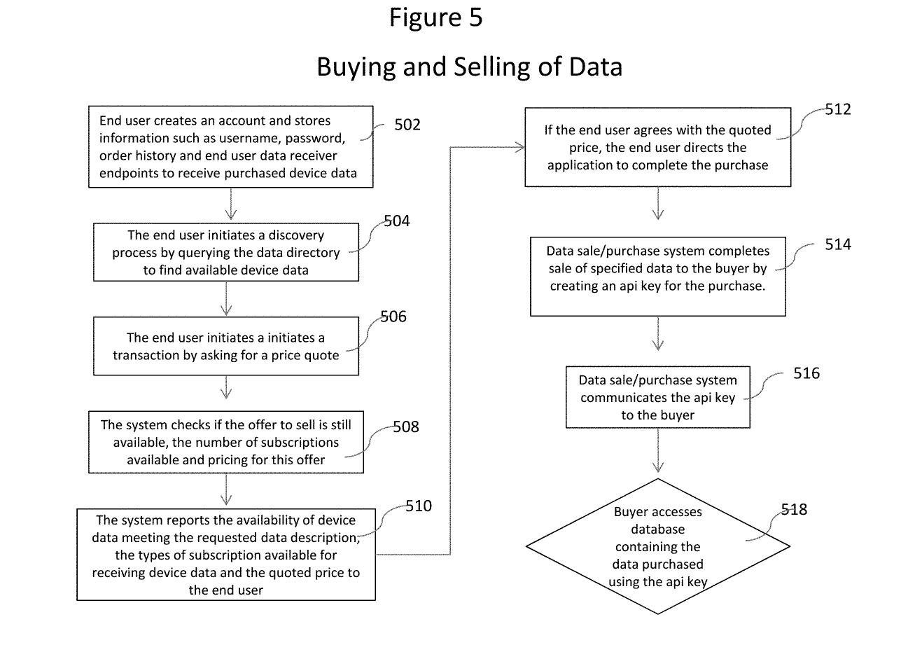

FIG. 5 illustrates illustrating various steps involved in device data transactions such as buying and selling of device data using the method and system according to an embodiment. In an embodiment, the end user may create an account with the application and the datamart data sale and purchase system and store information such as username, password, order history and end user data receiver endpoints to receive purchased device data via step 502. The end user may initiate a discovery process using a data discovery and purchase application via step 504 by querying the data directory to find available device data.

Once the end user finds the device data required using the directory during discovery process, it accesses the datamart system entity and initiates a transaction by asking for a price quote for device data meeting the requested data description and the types of subscription available via step 506. The datamart system entity checks if the offer to sell is still available, the number of subscriptions available and pricing for this offer via step 508 based on different parameters such as but not limited to type of data, amount of data, duration of purchase, maximum number of allowed subscriptions, and the pricing criteria for acceptance such as price match if it is “fixed price”, best price available if it is “best offer” or minimum threshold price if “above certain threshold” etc. The application may report the availability of device data meeting the requested data description, the types of subscription available for receiving device data and the quoted price to the end user via step 510. If the end user agrees with the quoted price, the end user may direct the application to complete the purchase via step 512.

The datamart data sale and purchase system then completes the sale of the specified device data to the buyer and creates an API key for that particular purchase via step 514. The datamart would send to the application an API key for that account ID to access device data in the particular containers based on the purchase parameters via step 516, and the application may forward the API key to the end user or store the API key in the end user's account at the application. The end user can then access the device data stored in specific containers using the API key via step 518. If the purchase is valid for certain duration, the API key is programmed to expire after that duration, at which time the buyer may extend the usage by purchasing additional duration or start a new discovery and/or purchase process.

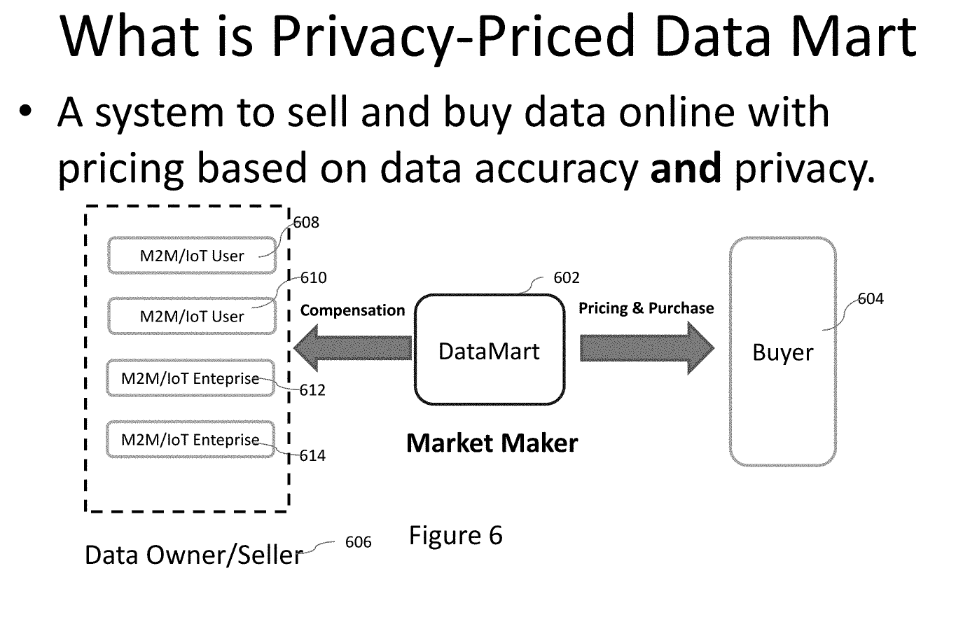

FIG. 6 illustrates an example of a system 602 to sell and buy data online with pricing based on data accuracy and privacy. Pricing according to importance of privacy in acquired data is important since privacy has value and data collected from sensors (sensor data, also known as source data or device data) can be intrusive. A system based only on permission by the party from whom the data is collected, a data owner 606 does not value privacy in a market setting. Compensating data owner 606 for privacy loss incentivizes the owner to share data, which facilitates market formation and growth. Data owner 606 can be a person, for example, M2M or IoT user 606, 608 or a corporation, for example, M2M or IoT enterprise 610, 612.

DataMart 602 aggregates data from all data owners or sellers 606. Each seller 606 sets a “privacy price”, which is the maximum price of the true source data. DataMart 602 uses a distribution function to slice the seller price into different pricing tiers depending on the accuracy, mix of unwanted data with the desired data and timing such that the “noisier” and/or “staler” the data, the lower the price. Buyer 604 asks for a price quote for a data query, buyer 604 accepts a price quote and queries data. DataMart 602 adjusts data accuracy by the accepted price and sends the final data product to the buyer 604. DataMart 602 charges the buyer 604 and sends compensation to the data owner/seller 606 for the completed transaction.

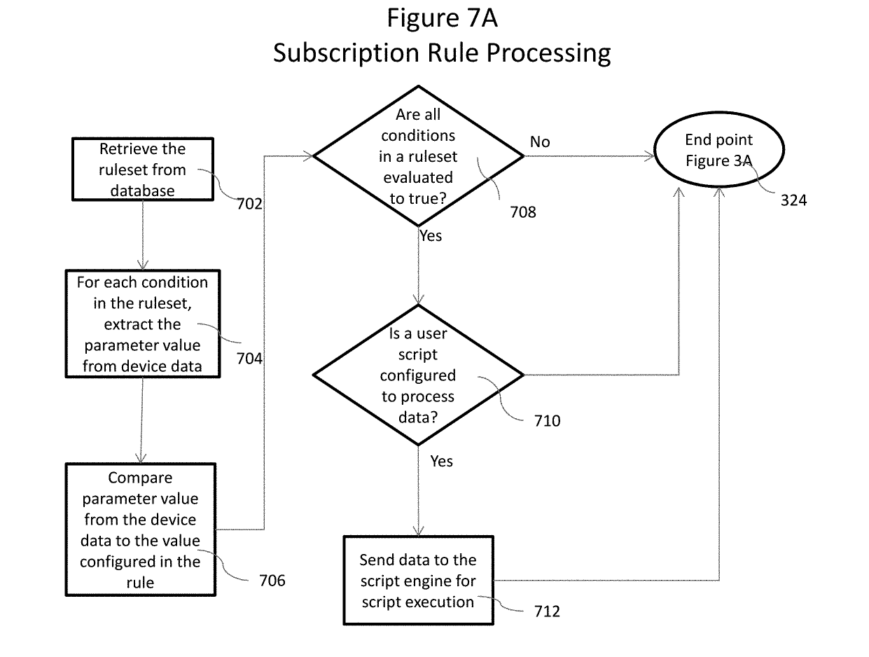

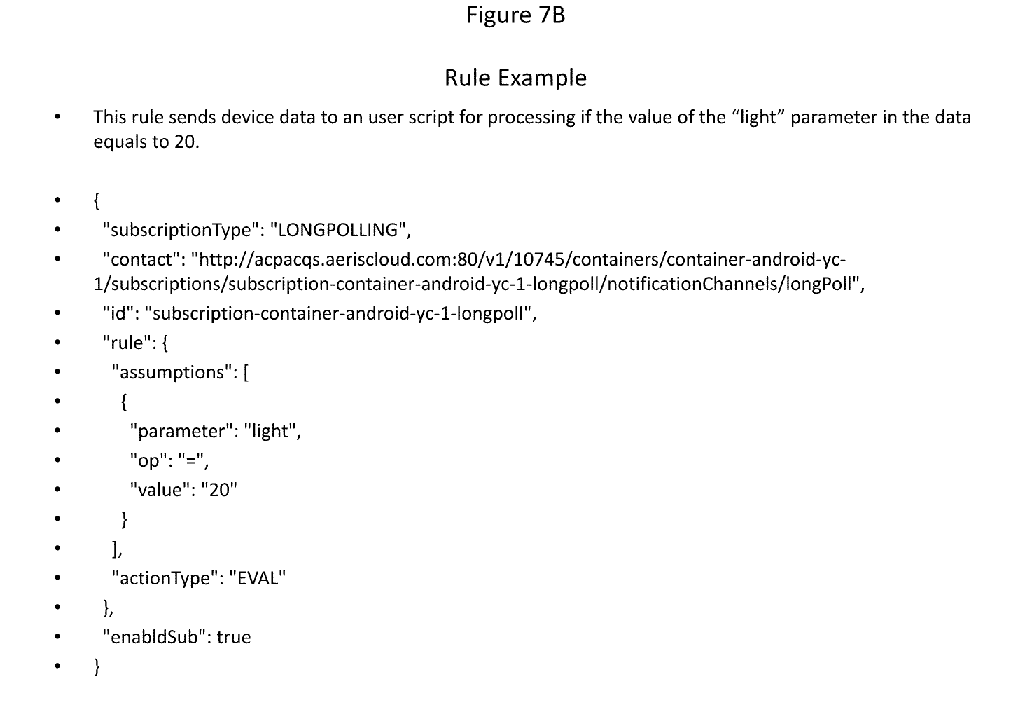

FIG. 7a is a flow diagram illustrating various steps involved in processing device feed data using subscription rules, step 322, as shown in FIG. 3A. “Rules” or “scripts” are used to filter device data when the end users subscribe to a real-time feed. The system checks if any subscription is configured with the data via step 318; if so, it stores the device data in a publishing queue based on the rule selected by the user (in this example, first in first out or FIFO) step 320, and processes subscription rules via step 322 as shown in FIG. 3A. To process the subscription rules, as shown in FIG. 7A, the system first retrieves the rule-set from the database via step 702. For each condition in the rule-set, it extracts a parameter value from the device data via step 704 and compares the parameter value from the device data to the value configured in the rule via step 706. If it finds that all conditions in a rule-set evaluated are true step 708, it further checks for a user script configured to process data via step 710. If a user script is so configured, it sends the data to the script engine for script execution step 712. If all conditions in a rule-set evaluated are not true or if no user script is configured to process data, the data is stored away without further processing via step 324 as shown in FIG. 3A.

FIG. 7B illustrates an example of a rule where device data is sent to a user script for processing if the value of the “light” parameter in the data equals to “20”. As shown in FIG. 7B, a subscription is associated with a rule. Each data model can have multiple rule subscriptions. The rule comprises of one or more conditions resulting in actions, an action type based on an outcome of evaluation of the rules, and a set of instructions to be carried out by an executable program to carry out the action type based on the outcome of evaluation of the rules. A condition consists of 3 parts: parameter, operator and value. As illustrated in the rule example, “parameter” is defined as “light”, operator “op” is defined as “=” and “value” is defined as“20”. The rule example further illustrates “action type” defined as “EVAL”, and when all the conditions evaluated are true, the action specified in the subscription is performed as shown by “enabldSub”: “true.

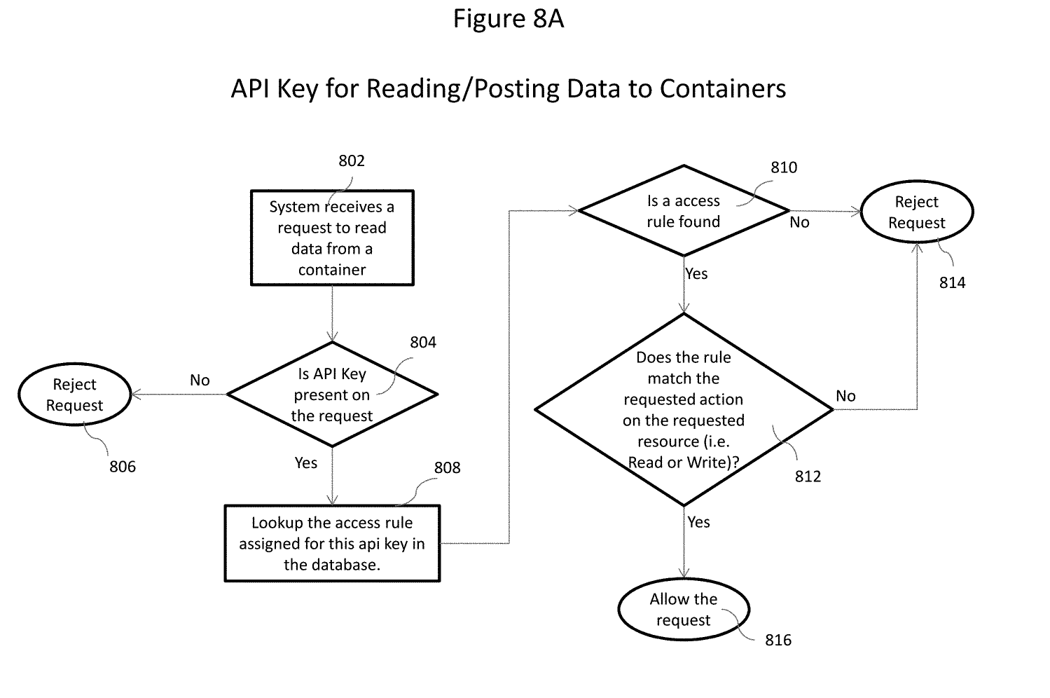

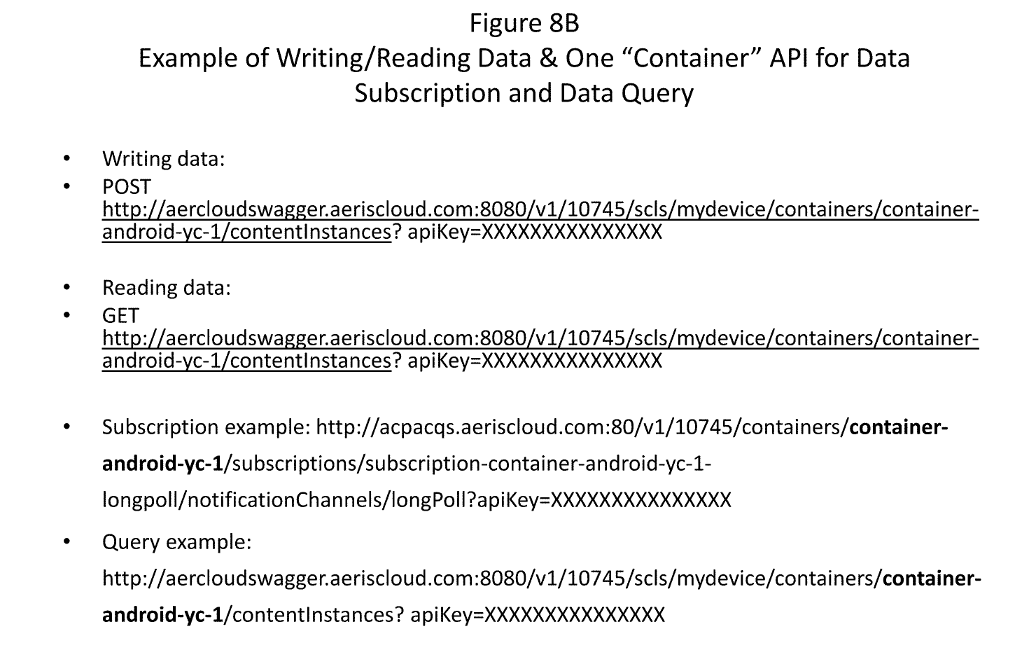

FIG. 8A is a flow diagram illustrating use of an API key to govern access to containers for end users either for devices to post data to the container or for end users or end user applications to retrieve device data from a container. The API key is created, in an embodiment, using an account key. The account key can also be an API key, however, an API key is not always an account key. The API key is assigned read or access privileges such as read and/or write to individual resources.

As the device data management system receives a request to write data to a container, for example from devices to post data, or to read data from a container, for example from end users with subscriptions to access data via step 602, it checks for the presence of an API key on the request via step 604. Or as the device data management system receives a request to read device data from a container via step 802, for example from end users who purchased access to certain device data, it checks for the presence of an API key on the request via step 804. If no such key is found, the system rejects the request via step 806. If the API key is present on the request, the system looks up the access rule assigned for this API key in the database via step 808. The request is rejected if the access rule is not found via step 814. If the access rule is found it checks to see if the rule matches the requested action on the requested resource via step 812, for example, read device data from a particular container. If the rule matches the requested action, the request is allowed via step 816, and if the rule does not match the requested action, the request is rejected via step 814.

FIG. 8B illustrates examples of reading and writing device data and one “container” API for both data subscription and data query. The device data management system may receive a request to read device data from a container, for example, from subscriber applications or from subscribers or other clients to access device data. The access to device data can be based on a subscription involving a push function, where the device data is pushed to the end user or end user application after processing, or to allow the end user to send a query to retrieve device data from the data management system, either as requested or according to a schedule. The system uses the URL path of the request to determine whether to retrieve device data that has been placed in a queue for a push subscription or, to satisfy a one-time or scheduled polling query, to retrieve all device data satisfying the query parameters.

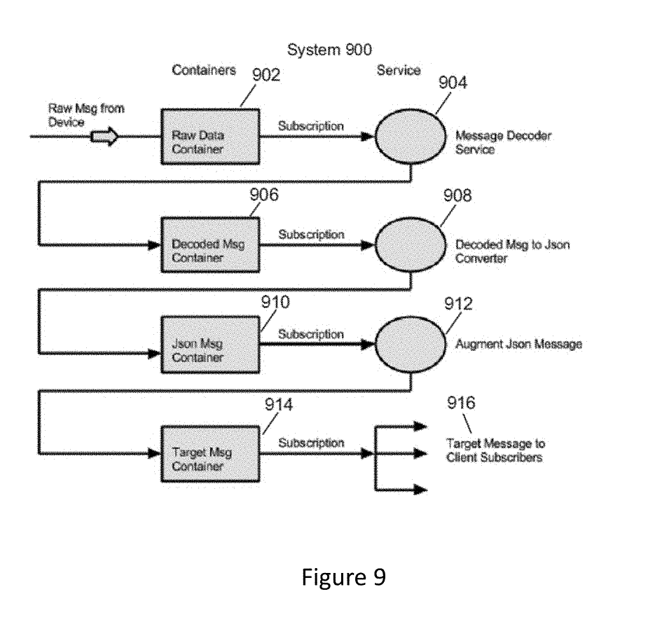

FIG. 9 illustrates processing of raw device data as directed by subscription information, according to an embodiment of the present invention. System 900 comprises various containers and the performance of services associated with subscriptions on data in those containers. As shown, a device posts http messages with binary payload to raw data container 902 which contains a number of binary messages. The subscription configured to the raw data container 902 sends the data stream through a binary decoder service 904 and reposts the decoded and modified data to the decoded message container 906. The subscription configured to the decoded message container then posts the data through a message sent to the Json converter 908, which reposts the processed data to the Json message container 910. The subscription configured to the Json message container then posts the data through Augment Json Message 912 for processing using a data decoration mapping function or augmentation service and then posts augmented data to target message container 914 to which all the end users holding appropriate API keys 916 can subscribe to receive the augmented data.

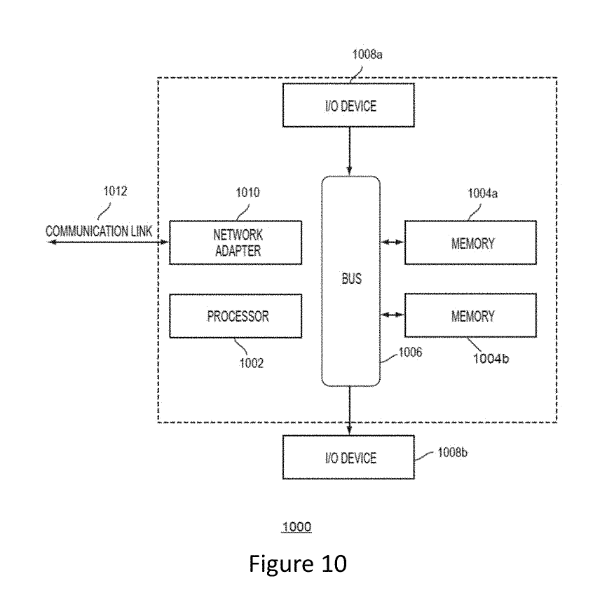

FIG. 10 illustrates a data processing system 1000 suitable for storing the computer program product and/or executing program code in accordance with an embodiment of the present invention. The data processing system 1000 includes a processor 1002 coupled to memory elements 1004a-b through a system bus 1006. In other embodiments, the data processing system 1000 may include more than one processor and each processor may be coupled directly or indirectly to one or more memory elements through a system bus.

Memory elements 1004a-b can include local memory employed during actual execution of the program code, bulk storage, and cache memories that provide temporary storage of at least some program code in order to reduce the number of times the code must be retrieved from bulk storage during execution. As shown, input/output or I/O devices 1008a-b (including, but not limited to, keyboards, displays, pointing devices, etc.) are coupled to the data processing system 1000. I/O devices 1008a-b may be coupled to the data processing system 1000 directly or indirectly through intervening I/O controllers (not shown).

In FIG. 10, a network adapter 1010 is coupled to the data processing system 1002 to enable data processing system 1002 to become coupled to other data processing systems or remote printers or storage devices through communication link 1012. Communication link 1012 can be a private or public network. Modems, cable modems, and Ethernet cards are just a few of the currently available types of network adapters.

Embodiments described herein can take the form of an entirely hardware implementation, an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W). To describe the features of the present disclosure in more detail refer now to the following description in conjunction with the accompanying Figures.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

Similarly, it is envisioned by the present invention that the term communications network includes communications across a network (such as that of a network for machine-to-machine or M2M communications but not limited thereto) using one or more communication architectures, methods, and networks, including but not limited to: Code division multiple access (CDMA), Global System for Mobile Communications (GSM) (“GSM” is a trademark of the GSM Association), Universal Mobile Telecommunications System (UMTS), Long Term Evolution (LTE), 4G LTE, wireless local area network (WIFI), and one or more wired networks.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims. Many other embodiments of the present invention are also envisioned.

1. A computer-implemented method for transactions involving device data due to operations of one or more devices comprising:
transforming, by applying rules, the device data from the one or more devices into formatted device data that is useable for the transactions;
sending the formatted device data to a storage location;
generating a descriptive listing of the formatted device data;
providing public access to the descriptive listing; and
facilitating transactions involving the formatted device data in response to receiving information from the descriptive listing.

2. The method of claim 1, wherein transforming, by applying rules, the device data from the one or more devices into formatted device data that is useable for the transactions further comprises using one or more data descriptions to describe type of data received from a plurality of devices.

3. The method of claim 1, wherein sending the formatted device data to a storage location further comprises grouping the received type of data into a plurality of containers based on the data descriptions.

4. The method of claim 1, wherein generating a descriptive listing of the formatted device data and providing public access to the descriptive listing further comprises publishing the type of device data available indexed by data description thereby enabling at least one end user to select device data based on data description.

5. The method of claim 4, wherein the data description further comprises data parameters containing any of account ID, container ID, meta data of the data model, relevance, privacy configuration, price and a combination thereof.

6. The method of claim 1, wherein facilitating transactions involving the formatted device data in response to receiving information from the descriptive listing further comprises display a rating for the available device data based on any of relevance, frequency of availability, quality of device data from a particular source and a combination thereof.

7. The method of claim 6, wherein the quality of device data further comprises any of completeness, accuracy and a combination thereof.

8. The method of claim 1, wherein facilitating transactions involving the formatted device data in response to receiving information from the descriptive listing further comprises enabling sale and purchase of the selected device data by configuring at least one API key to at least one of the plurality of containers, wherein the at least one API key is associated with a receiver endpoint and at least one rule identified by the API key.

9. A system for transactions involving device data due to operations of one or more devices comprising:
a database to receive data from one or more devices;
a module for transforming, by applying rules, the device data from the one or more devices into formatted device data that is useable for the transactions;
sending the formatted device data to a storage location;
generating a descriptive listing of the formatted device data; and
providing public access to the descriptive listing; and
a gateway for facilitating transactions involving the formatted device data in response to receiving information from the descriptive listing.

10. The system of claim 9, wherein transforming, by applying rules, the device data from the one or more devices into formatted device data that is useable for the transactions further comprises using one or more data descriptions to describe type of data received from a plurality of devices.

11. The system of claim 9, wherein sending the formatted device data to a storage location further comprises grouping the received type of data into a plurality of containers based on the data descriptions.

12. The system of claim 9, wherein generating a descriptive listing of the formatted device data and providing public access to the descriptive listing further comprises publishing the type of device data available indexed by data description thereby enabling at least one end user to select device data based on data description.

13. The system of claim 12, wherein the data description further comprises data parameters containing any of account ID, container ID, meta data of the data model, relevance, privacy configuration, price and a combination thereof.

14. The system of claim 9, wherein facilitating transactions involving the formatted device data in response to receiving information from the descriptive listing further comprises display a rating for the available device data based on any of relevance, frequency of availability, quality of device data from a particular source and a combination thereof.

15. The system of claim 14, wherein the quality of device data further comprises any of completeness, accuracy and a combination thereof.

16. The system of claim 9, wherein facilitating transactions involving the formatted device data in response to receiving information from the descriptive listing further comprises enabling sale and purchase of the selected device data by configuring at least one API key to at least one of the plurality of containers, wherein the at least one API key is associated with a receiver endpoint and at least one rule identified by the API key.

17. A computer program product stored on a non-transitory computer readable medium for for transactions involving device data due to operations of one or more devices comprising:
a processor, and
a memory in communication with the processor wherein the memory containing program instructions which when executed by the processor, perform the following operations comprising:
transforming, by applying rules, the device data from the one or more devices into formatted device data that is useable for the transactions;
sending the formatted device data to a storage location;
generating a descriptive listing of the formatted device data;
providing public access to the descriptive listing; and
facilitating transactions involving the formatted device data in response to receiving information from the descriptive listing.

18. The computer program product of claim 17, wherein transforming, by applying rules, the device data from the one or more devices into formatted device data that is useable for the transactions further comprises using one or more data descriptions to describe type of data received from a plurality of devices.

19. The computer program product of claim 17, wherein sending the formatted device data to a storage location further comprises grouping the received type of data into a plurality of containers based on the data descriptions.

20. The computer program product of claim 17, wherein generating a descriptive listing of the formatted device data and providing public access to the descriptive listing further comprises publishing the type of device data available indexed by data description thereby enabling at least one end user to select device data based on data description.

21. The computer program product of claim 20, wherein the data description further comprises data parameters containing any of account ID, container ID, meta data of the data model, relevance, privacy configuration, price and a combination thereof.

22. The computer program product of claim 17, wherein facilitating transactions involving the formatted device data in response to receiving information from the descriptive listing further comprises display a rating for the available device data based on any of relevance, frequency of availability, quality of device data from a particular source and a combination thereof.

23. The computer program product of claim 22, wherein the quality of device data further comprises any of completeness, accuracy and a combination thereof.

24. The computer program product of claim 17, wherein facilitating transactions involving the formatted device data in response to receiving information from the descriptive listing further comprises enabling sale and purchase of the selected device data by configuring at least one API key to at least one of the plurality of containers, wherein the at least one API key is associated with a receiver endpoint and at least one rule identified by the API key.
